(19) United States
(12) Patent Application Publication
(10) Pub. No.: US 2013/0107887 A1
(43) Pub. Date: May 2, 2013

(54) MAINTAINING VIRTUAL NETWORK CONTEXT ACROSS MULTIPLE INFRASTRUCTURES

(71) Applicants: Mark A. Pearson, Applegate, CA (US); Stephen G. Low, Austin, TX (US)

(72) Inventors: Mark A. Pearson, Applegate, CA (US); Stephen G. Low, Austin, TX (US)

(21) Appl. No.: 13/282,115

(22) Filed: Oct. 26, 2011

(51) Int. Cl. H04L 12/56

(52) U.S. Cl. 370/401

(57) ABSTRACT

In a method for maintaining virtual network context across multiple infrastructures, a data packet having a virtual network identifier in a first routing infrastructure is accessed, wherein the virtual network identifier indicates a tenant network. The data packet is encapsulated for transport of the data packet through a second routing infrastructure. In addition, the virtual network identifier is inserted into the encapsulation of the data packet for routing of the data packet through the second routing infrastructure while maintaining virtual network context and identification between the first routing infrastructure and the second routing infrastructure, wherein the first routing infrastructure operates under a first virtual networking technology and the second routing infrastructure operates under a second virtual networking technology.

### BACKGROUND

With continued advancements in client-server computing arrangements, data centers are no longer required to be located in a centralized location and/or housed within a specialized data center. Instead, various resources typically offered in data centers may be distributed to multiple data center sub-locations, which may be geographically distant from each other. In one regard, infrastructure associated with the Internet can be used to provide some portion of network resources, such as, communications between the distributed resources.

There have also been significant increases in the implementation of cloud computing services, which provide on-demand access to computing system resources via a network, such as the Internet, and/or provide software as a service. In previous computing configurations, dedicated data center resources, including servers and storage resources, have typically been allocated to only a single tenant. In addition, data and software may have been contained on the dedicated data center resources. With continued advancements in cloud computing, computing systems in data centers that include servers, storage resources, network resources, and/or software, are now available as needed to multiple tenants.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of a packet transport environment, according to an example of the present disclosure;

FIG. 2 shows a block diagram of a gateway, according to an example of the present disclosure;

FIG. 3 shows a flow diagram of a method for maintaining virtual network context and identification between routing infrastructures that operate under different virtual networking technologies, according to an example of the present disclosure;

FIG. 4 depicts a diagram of frames of data packets under various frame formats, according to an example of the present disclosure; and

FIG. 5 illustrates a computer system, which may be employed to perform various functions described herein, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Disclosed herein are a method and apparatus for maintaining virtual network context and identification between multiple routing infrastructures that operate under different virtual networking technologies. According to an example, a first virtual networking technology comprises the IEEE 802.1 technology, which is also known as Ethernet, including derivatives of the IEEE 802.1 technology. In addition, a second virtual networking technology comprises the Internet Protocol Generic Routing Encapsulation (IP-GRE) technologies. As discussed in greater detail herein below, a virtual network identifier in a data packet is transferred or inserted at points where the first and second virtual networking technologies interface. In addition, an instance of a virtual network that is transported by the two networking technologies is created, but the instance of the virtual network appears as a single service to members of the virtual network and maintains a single virtual network identifier.

In one regard, the virtual network identifier is used to indicate a tenant network in a virtualized data center. The tenant network is logically isolated from other tenant networks even though they share a physical network. The method and apparatus disclosed herein generally enables a virtualized data center tenant network to be identified inside a data packet even through different network transport technologies that carry the data packet end-to-end.

The method and apparatus disclosed herein enable the virtual network identifier to maintain the same value across the different networking technologies. As such, the management and orchestration of the virtual network identifier name space may be simplified because one data set of virtual network identifiers is used across the different networking technologies. Moreover, identification of the virtual network of an inspected data packet may be determined even though the virtual network may be transported by two different technologies. Furthermore, quality of service indicators may be transferred between two different transport technologies to affect an equal traffic treatment end-to-end for the virtual network instance.

Through implementation of the method and apparatus disclosed herein, a virtual network that stands end-to-end across multiple routing infrastructures that operate under different virtual networking technologies is provided. More particularly, a virtual network that spans across and between routing infrastructures that implement Ethernet technology and a routing infrastructure that implements IP-GRE technologies is provided. In other words, the method and apparatus disclosed herein allow for the creation of a data center virtualized network Layer 2 instance that can span across Layer 3 IP routing infrastructures. The method and apparatus disclosed herein also allow for the interoperability and interfacing of Ethernet technologies and IP GRE technologies to represent a single virtual network. As used herein, a virtual network or virtual local area network (VLAN) may be defined as a set of physical resources that has been subdivided into logical contexts that are separate from other logical contexts.

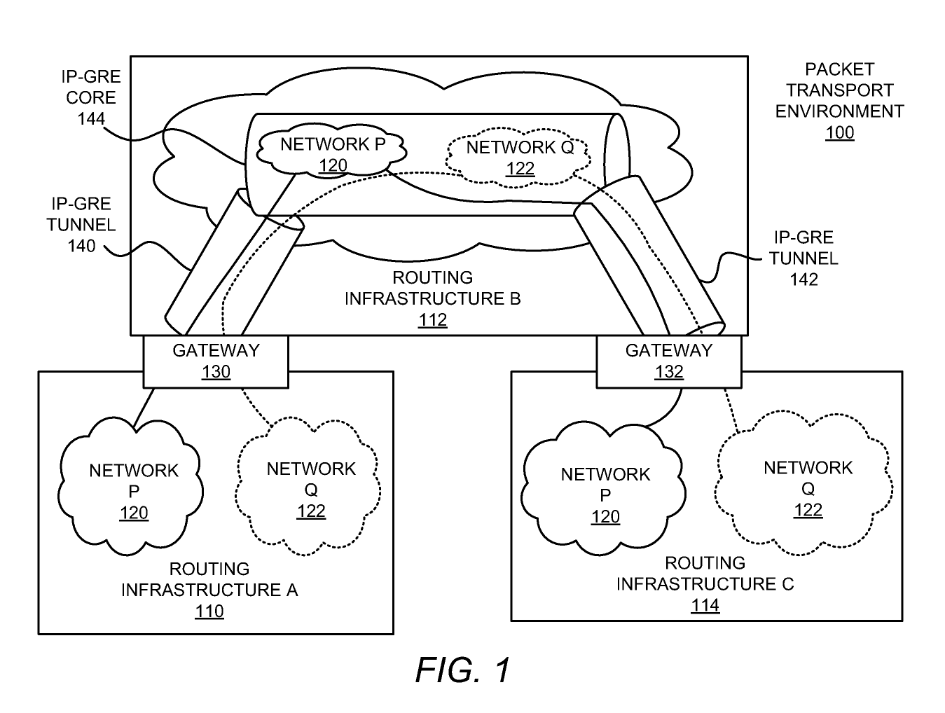

With reference first to FIG. 1, there is shown a diagram of a packet transport environment 100 in which various aspects of the method and apparatus disclosed herein may be implemented, according to an example. It should be clearly understood that the packet transport environment 100 may include additional components and that some of the components described herein may be removed and/or modified without departing from a scope of the packet transport environment 100. As such, for instance, the packet transport environment 100 may include any number of routing infrastructures, gateways, etc.

As shown in FIG. 1, the packet transport environment 100 is depicted as including a first routing infrastructure 110, a second routing infrastructure 112, a third routing infrastructure 114, and gateways 130, 132. According to an example, the first routing infrastructure 110 and the third routing infrastructure 114 operate under a first virtual networking technology. In addition, the second routing infrastructure 112 operates under a second virtual networking technology, which differs from the first virtual networking technology. By way of particular example, the first virtual networking technology comprises Ethernet and the second virtual networking technology comprises Internet Protocol Generic Routing Encapsulation (IP-GRE). In this regard, the first virtual networking technology implements Layer 2 of the Open Systems Interconnection (OSI) model and the second virtual networking technology implements Layer 3 of the OSI model.

The Ethernet technologies include, for instance, customer virtual local area networks (C-VLANs), service VLANs (S-VLANs), backbone VLANs (B-VLANs), service instance identifiers (I-SIDs), and similar derivatives. Generally, the Ethernet technologies are described in standards as C-VLAN, Provider Bridging, and Provider Backbone Bridging. Derivatives may include vendor proprietary VLAN tags.

Layer 2 Ethernet technologies include mechanisms for creating virtual networks, such as, virtual local area networks (VLANs). In addition, Layer 3 IP-GRE technologies also include mechanisms for creating virtual networks. According to an example, the virtual networks in each of the Layer 2 Ethernet technologies and the Layer 3 IP-GRE technologies are explicitly identified by respective virtual network identifiers (VIDs) contained in the data packets that are transported through the routing infrastructures 110-114. As discussed in greater detail herein below, the gateways 130, 132 generally operate to maintain the VID in the data packets transported across the different virtual network technologies. More particularly, for instance, the gateways 130, 132 may translate the packet fields in the data packets from the Layer-2 format to the Layer-3 format, and back to the Layer-2 format.

According to an example, the packet transport environment 100 comprises at least one data center or sub-locations of a data center. In this regard, the first and third routing infrastructures 110 and 114, which may be part of the same data center or different data centers, may be located in different geographic locations with respect to each other. In addition, the first and third routing infrastructures 110 and 114 are connected to each other through the second routing infrastructure 112. Moreover, each of the virtual networks 120, 122 may be in communication with various electronic devices, such as, servers, client devices, network switches, routers, etc. In one example, therefore, a data packet originating in the first routing infrastructure 110 is assigned a VID, which is included in a packet field of the data packet. The VID may also be considered as a multitenant network identifier because the VID has the same meaning in each of the different routing infrastructures 110-114. In this regard, the VIDs are shared among the different routing infrastructures 110-114.

Shown in FIG. 1 are examples of two virtual networks P and Q 120, 122 that have been maintained across the packet transport environment 100. The virtual network Q 122 has been shown with dotted lines to distinguish that virtual network from the other virtual network P 120. As also shown in FIG. 1, each of the virtual networks 120 and 122 is maintained in each of the routing infrastructures 110-114. This is accomplished by maintaining the VIDs associated with each of the respective virtual networks 110-114 as the data packets are transported through the gateways 130, 132. As discussed in greater detail herein below, the gateways 130, 132 translate the VIDs between the different routing infrastructures 110-114.

According to an example in which a data packet in the first routing infrastructure 110 is to be transported to a device in the third routing infrastructure 114, the data packet may be assigned a VID for a virtual network 120. The VID generally distinguishes the virtual network 120 from other virtual networks. A virtual network management server (not shown) may manage the assignment of the VID and may also communicate the assignment of the VIDs to devices in each of the routing infrastructures 110-114. In any regard, the VID, which may also be considered a tenant network identifier or a multiple tenant network identifier, is to be inserted into a field of the data packet. A device and/or a set of machine readable instructions stored on a device may insert the VID into the data packet field. Various examples of where the VID may be inserted into different types of frame formats are described in greater detail herein below.

In any regard, the gateway 130 is to receive a data packet comprising the VID and is to determine that the data packet is to be transported through the second routing infrastructure 112 to reach the third routing infrastructure 114. According to an example, the gateway 130 makes this determination by comparing the VID to information contained in a routing table. In these instances, the gateway 130 is to encapsulate the data packet for routing of the data packet through the second routing infrastructure 112. In addition, the gateway 130 is to insert the VID into the encapsulation of the data packet. Moreover, as depicted in FIG. 1, the data packet is to be routed through the IP-GRE tunnel 140, the IP-GRE Core 144, and the IP-GRE tunnel 142 of second routing infrastructure 112. As also shown in FIG. 1, the virtual networks 120 and 122 are to be maintained in the second and third routing infrastructures 112, 114 because the VID of the data packet remains the same.

Following the transport of the data packet through the second routing infrastructure 112, another gateway 132 receives the data packet. The gateway 132 accesses the data packet and determines the VID contained in a packet field of the data packet. In addition, the gateway 132 is to decapsulate the data packet such that the data packet may be transported through the third routing infrastructure 114. Moreover, the virtual network of the data packet is maintained in the third routing infrastructure 114 because the VID remains the same in the packet field of the data packet.

The gateways 130, 132 comprise any of various types of devices, such as, servers, routers, switches, etc., positioned at the first and third routing infrastructures 110, 114. The gateways 130, 132 may also comprise machine readable instructions stored on a device. According to a particular example, the gateways 130, 132 comprise virtual switches, such as hypervisors, operating on a server(s). The hypervisor, also called a virtual machine monitor, is a virtualization technique executing on a server to provide a platform on which to execute multiple operating systems concurrently, thereby supporting multiple virtual machines on a host server. In this regard, although the gateways 130, 132 have been depicted in FIG. 1 as comprising physical interfaces between the first and third routing infrastructures 110, 114 and the second routing infrastructure 112, the gateways 130, 132 may comprise machine readable instructions operable to encapsulate and decapsulate data packets for transport between the first, second, and third routing infrastructures 110-114. In addition, or alternatively, the gateways 130 and 132 may be provided in the first and third routing infrastructures 110, 114 or the second routing infrastructure 112, or both.

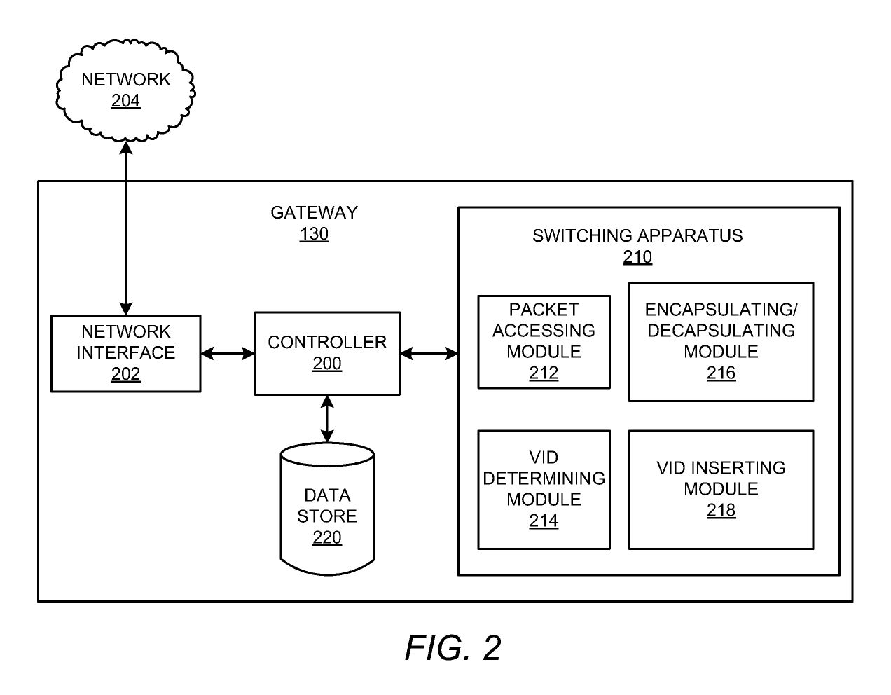

Turning now to FIG. 2, there is shown a more detailed block diagram of the gateway 130 depicted in FIG. 1, according to an example. It should be understood that the gateway 130 may include additional elements and that some of the elements depicted therein may be removed and/or modified without departing from a scope of the gateway 130. In addition, it should be understood that the gateway 132 may comprise similar features to the gateway 130.

As shown in FIG. 2, the gateway 130 includes a controller 200, a network interface 202, a switching apparatus 210, and a data store 220. The switching apparatus 210 has also been depicted as including a packet accessing module 212, a VID determining module 214, an encapsulating/decapsulating module 216, and a VID inserting module 218. The network interface 202 generally includes various hardware and/or software components for enabling communications of data to and from a network 204. The network 204 may comprise a local area network, a wide area network, the Internet, etc. In addition, although a single network 204 has been depicted in FIG. 2, the gateway 130 may be connected to multiple networks 204. In this instance, the gateway 130 may be connected to both a LAN and the Internet, for instance, as shown in FIG. 1.

According to an example, the gateway 130 comprises a physical device, such as, a router, a switch, a server, etc. In another example, the gateway 130 and/or the switching apparatus 210 comprise machine readable instructions operable on a computing device. In this example, the gateway 130 and/or the switching apparatus 210 comprises a virtual switch, an Ethernet switch, a Layer 3 router, etc.

The controller 200 may comprise a microprocessor, a micro-controller, an application specific integrated circuit (ASIC), and the like. The controller 200 is to perform various processing functions in the gateway 130. Some of the processing functions include invoking or implementing the modules 212-218 contained in the switching apparatus 210 as discussed in greater detail herein below.

According to an example, the switching apparatus 210 comprises a hardware device, such as, a circuit or multiple circuits arranged on a board. In this example, the modules 212-218 comprise circuit components or individual circuits. According to another example, the switching apparatus 210 comprises machine readable instructions stored, for instance, in a volatile or non-volatile memory, such as dynamic random access memory (DRAM), electrically erasable programmable read-only memory (EEPROM), magnetoresistive random access memory (MRAM), Memristor, flash memory, floppy disk, a compact disc read only memory (CD-ROM), a digital video disc read only memory (DVD-ROM), or other optical or magnetic media, and the like. In this example, the modules 212-218 comprise software modules stored in the memory. According to a further example, the modules 212-218 comprise a combination of hardware and software modules.

The data store 220 may comprise various information pertaining to whether particular data packets are to be transported to other routing infrastructures. The data store 220 comprises volatile and/or non-volatile memory, such as DRAM, EEPROM, MRAM, phase change RAM (PCRAM), Memristor, flash memory, and the like. In addition, or alternatively, the data store 220 comprises a device that is to read from and write to a removable media, such as, a floppy disk, a CD-ROM, a DVD-ROM, or other optical or magnetic media.

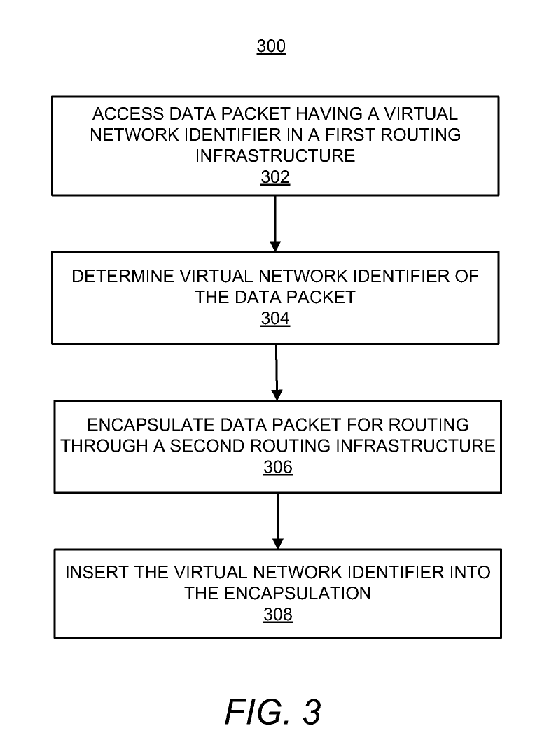

Various manners in which the switching apparatus 210 may be implemented are discussed in greater detail with respect to the method 300 depicted in FIG. 3. FIG. 3, more particularly, depicts a flow diagram of a method 300 for maintaining virtual network context and identification between routing infrastructures that operate under different virtual networking technologies, according to an example. It should be apparent to those of ordinary skill in the art that the method 300 represents a generalized illustration and that other steps may be added or existing steps may be removed, modified or rearranged without departing from a scope of the method 300. Although particular reference is made to the packet transport environment 100 and the switching apparatus 210 depicted in FIGS. 1 and 2 as comprising environments in which the operations described in the method 300 may be performed, it should be understood that the method 300 may be performed in differently configured systems and apparatuses without departing from a scope of the method 300.

At block 302, a data packet having a VID is accessed in a first routing infrastructure 110, for instance, by the packet accessing module 212. According to an example, the gateway 130 receives the data packet from a device within the first routing infrastructure 110 for the data packet to be transported to another routing infrastructure 114. In this regard, for instance, the gateway 130 may be situated at an edge of the first routing infrastructure 110 or at an edge of the second routing infrastructure 112.

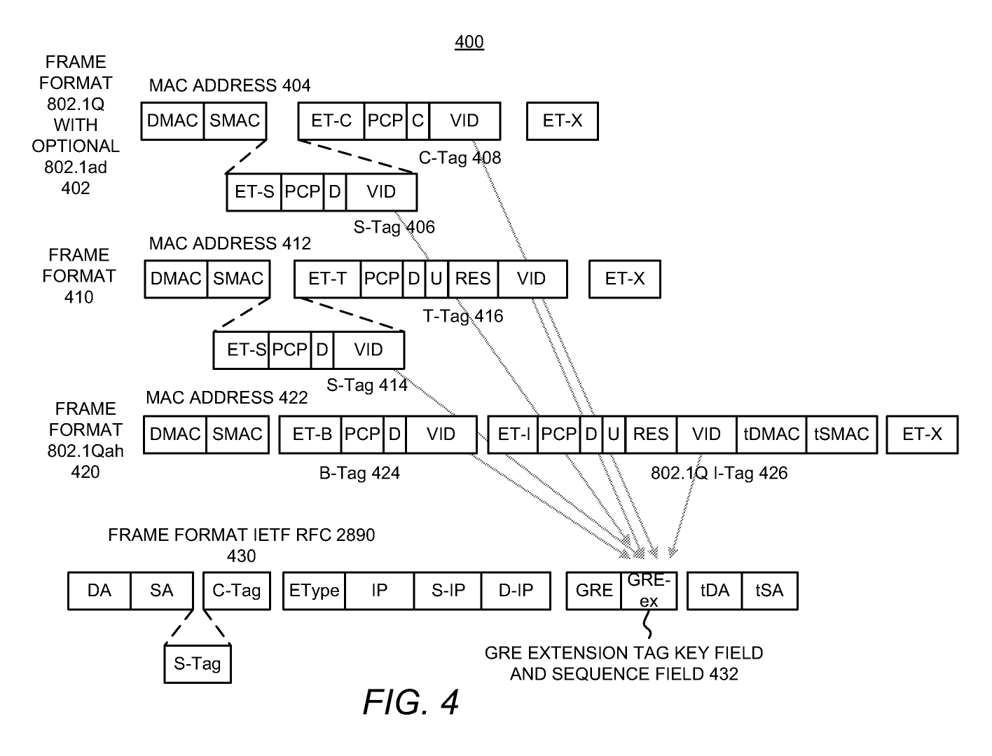

At block 304, the VID of the data packet is determined, for instance, by the VID determining module 214. The VID determining module 214 may determine the VID of the data packet through an examination of the data contained in a packet field, such as, the header, of the data packet. In one example, the VID may be contained in a particular field of the packet header. In addition, the location of the VID may vary depending upon the format of the data packet as discussed in greater detail herein below with respect to FIG. 4.

At block 306, the data packet is encapsulated for routing through a second routing infrastructure 112, for instance, by the encapsulating/decapsulating module 216. As discussed above, the second routing infrastructure 112 operates under a different virtual networking technology as compared with the first routing infrastructure 110. As such, the encapsulation of the data packet generally enables the data packet to be transported through the second routing infrastructure 112. According to an example, the data packet may be encapsulated with a frame format that complies with IETF RFC 2890 to enable the data packet to be transported through a routing infrastructure that employs Layer 3 IP-GRE technology.

At block 308, the VID of the data packet is inserted into the encapsulation, for instance, by the VID inserting module 218. More particularly, for instance, the VID inserting module 218 inserts the VID into at least a portion of a field of the encapsulation. By way of particular example, the VID inserting module 218 inserts the VID into at least a portion of a GRE extension tag KEY field and a GRE extension tag SEQUENCE field.

Although not shown in FIG. 3, the encapsulated data packet may be transported through the second routing infrastructure 112 through use of the encapsulation. More particularly, for instance, the encapsulated data packet may be sent on the egress IP-GRE interface. In addition, the ingress side of the IP-GRE interface may read the VID from the IP-GRE packet, such as, from the KEY and SEQUENCE fields, and may retain the VID for the egress Ethernet interface. Moreover, the data packet is tunneled through the second routing infrastructure 112, while maintaining the virtual network. In addition, the encapsulated data packet may be tunneled into the gateway 132 associated with the third routing infrastructure 114. The gateway 132 may decapsulate the data packet to remove the IP-GRE packet. The data packet, which is now in Ethernet form, is forwarded to an Ethernet interface. If the Ethernet interface does not have a VID, then the VID is added to the data packet. The value of the VID is the same as the one that added to the IP-GRE header. The data packet is then sent on the egress Ethernet interface. In this regard, the data packet may maintain its virtual network because the data packet retains the same VID. Moreover, the data packet may then be transported through the third routing infrastructure 114 to its destination, for instance, the destination MAC address defined in the frames, such as, the header, of the data packet.

According to another example, quality of service (QoS) indicators are also carried in encoded form in the VLAN tag. In the Ethernet frames, the QoS indicators are carried in the VLAN tag as the PCP (Priority Code Point) and the DEI (Drop Eligibility Indicator). In a GRE packet, network equipment will operate on the outer IP header ToS or DiffServ values and/or the outer Ethernet header VLAN tag. To preserve the original QoS treatments end to end, the values of the QoS indicators are transferred and/or translated to and from the IP ToS and/or DiffServ values of the outer IP header, and/or the outer VLAN tag that precedes the GRE header. According to an example, the QoS indicators of the original frame are also encoded into the GRE key or sequence fields, along with the VID, for restoration into the original frame when de-encapsulated.

Turning now to FIG. 4, there is shown a diagram 400 of frames of data packets under various frame formats, such as, 802.1Qad, 802.1Qah, etc., and IETF RFC 2890, according to an example. It should be clearly understood that the data packet frames depicted in FIG. 4 is merely for illustrative purposes and thus, the data packet frames may include additional elements and that some of the elements described herein may be removed and/or modified.

Generally speaking, the diagram 400 shows that VIDs are provided in the data packet frames of frame formats 402, 410, and 420. In other words, the diagram 400 shows that the VIDs are carried inside the data packet in various types of Ethernet tags, such as, C-VLAN, S-VLAN, B-VLAN, I-SID, etc. In addition, the diagram 400 shows that the VIDs may be inserted into a data packet frame of frame format G 430, which comprises an IP-GRE transport technology. Thus, for instance, the diagram 400 shows a more detailed depiction of block 308 in FIG. 3. In addition, the frame formats 402, 410, and 420 comprise Layer 2 networking technologies, while the frame format G 430 comprises a Layer 3 networking technology.

FIG. 4 shows that a first frame format IEEE 802.1Q with optional 802.1ad 402 includes a Media Access Control (MAC) address portion 404. The MAC address portion 404 includes a destination MAC address (DMAC) and a source MAC address (SMAC). The first frame format 402 also includes an optional S-Tag 406, a C-Tag 408, and the Ethertype of the payload (ET-X). The second frame format 410 is depicted as including a MAC address portion 412, which includes a DMAC and a SMAC, followed by an optional S-Tag 414, a T-Tag 416, and an ET-X. The third frame format IEEE 802.Qah 420 is depicted as including a MAC address portion 422, including a DMAC and a SMAC, followed by a B-Tag 424, a 802.1Q I-Tag 426, and an ET-X.

The IEEE 802.1Q compliant frames having the optional C-Tag 408 enables up to 4096 VLANs labeled by a 12 bit VID. The optional S-Tag 406, 414, having an additional 12 bit VID, may be inserted in a frame in front of the C-Tag (as shown in frame format C 402) or the T-Tag (as shown in frame format D 410) to enable service VLANs or multi-channel support. A B-Tag 424 is identical to either an S-Tag or a C-Tag depending on whether the B-Tag includes an EtherType ET-S or ET-C as the ET-B portion. According to various examples, a default configuration may be for the B-Tag to have an EtherType of an S-Tag. The IEEE 802.1Qah definition is for the B-Tag to have the EtherType of an S-Tag.

As shown in the second frame format 410, the T-Tag 416 may include a VID having more than 12 bits, for instance, a 24 bit VID, which may be used to uniquely label more than 4096 VLANs. In some configurations, the T-Tag 416 may be used to uniquely label up to approximately sixteen million VLANs, or more. The VID in the T-Tag 416 is unique with global data center scope, providing network end-to-end invariability. The VID in the T-Tag 416 may also have an additional byte that includes 4 bits of Priority Code Points (PCPs) and drop eligibility (D) that are also carried end-to-end. The 24 bit VID and PCP remain in the frame end-to-end and may be used to verify VLAN membership.

A fourth frame format 430 comprises KEY and SEQUENCE number extensions to GRE under IETF RFC 2890. As such, the fourth frame format 430 includes a GRE extension tag KEY field and SEQUENCE field 432. The arrows from the VIDs in the frame formats 402, 410, and 420 are depicted as pointing to the GRE extension tag KEY field and SEQUENCE field 432. In this regard, the VID may be inserted into one or both of the GRE extension tag KEY field and SEQUENCE field 432 from any of the frame formats 402, 410, and 420.

Some or all of the operations set forth in the method 300 may be contained as a utility, program, or subprogram, in any desired computer accessible medium. In addition, the method 300 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

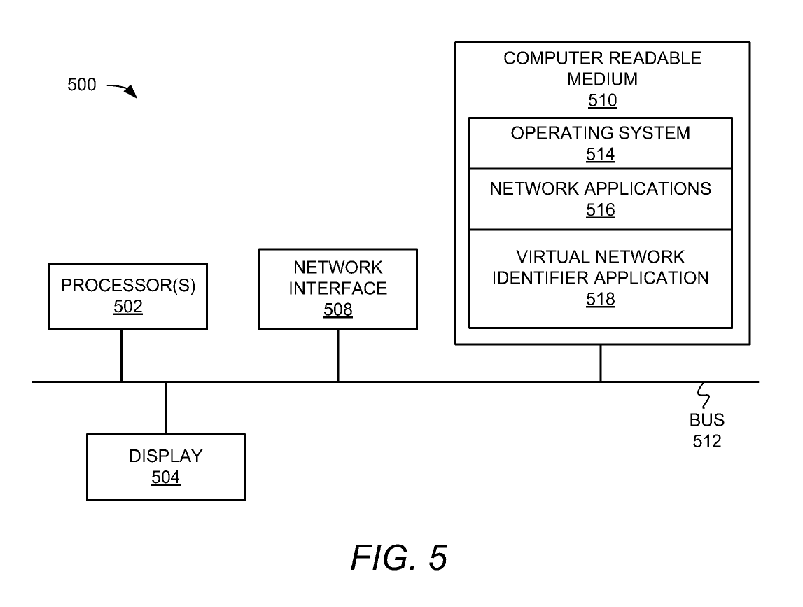

Turning now to FIG. 5, there is shown a schematic representation of a computing device 500 configured in accordance with examples of the present disclosure. The device 500 includes a processor 502, such as a central processing unit; a display device 504, such as a monitor; a network interface 508, such as a Local Area Network LAN, a wireless 802.11x LAN, a 3G mobile WAN or a WiMax WAN; and a computer-readable medium 510. Each of these components is operatively coupled to a bus 512. For example, the bus 512 may be an EISA, a PCI, a USB, a FireWire, a NuBus, or a PDS.

The computer readable medium 510 may be any suitable medium that participates in providing instructions to the processor 502 for execution. For example, the computer readable medium 510 may be non-volatile media, such as an optical or a magnetic disk; volatile media, such as memory. The computer-readable medium 510 may also store an operating system 514, such as Mac OS, MS Windows, Unix, or Linux; network applications 516; and a VID application 518. The operating system 514 may be multi-user, multiprocessing, multitasking, multithreading, real-time and the like. The operating system 514 may also perform basic tasks such as recognizing input from input devices, such as a keyboard or a keypad; sending output to the display 504; keeping track of files and directories on the computer readable medium 510; controlling peripheral devices, such as disk drives, printers, image capture device; and managing traffic on the bus 512. The network applications 516 include various components for establishing and maintaining network connections, such as machine readable instructions for implementing communication protocols including TCP/IP, HTTP, Ethernet, USB, and FireWire.

The VID application 518 provides various components for maintaining virtual network context and identification between multiple routing infrastructures, for instance, of a common virtual data center, as described above. The VID application 518 may thus comprise machine readable instructions of the switching apparatus 210 depicted in FIG. 2. In this regard, the VID application 518 may include various modules for accessing a data packet having a VID in a first routing infrastructure, encapsulating the data packet for transport of the data packet through a second routing infrastructure, and inserting the VID into the encapsulation of the data packet. In certain examples, some or all of the processes performed by the application 518 may be integrated into the operating system 514. In certain examples, the processes may be at least partially implemented in digital electronic circuitry, or in computer hardware, machine readable instructions (including firmware and/or software), or in any combination thereof.

Although described specifically throughout the entirety of the instant disclosure, representative examples of the present invention have utility over a wide range of applications, and the above discussion is not intended and should not be construed to be limiting, but is offered as an illustrative discussion of aspects of the invention.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for maintaining virtual network context across multiple infrastructures comprising:
accessing a data packet having a virtual network identifier in a first routing infrastructure, wherein the virtual network identifier indicates a tenant network;
encapsulating the data packet for transport through a second routing infrastructure; and
inserting the virtual network identifier into the encapsulation of the data packet for routing of the data packet through the second routing infrastructure while maintaining virtual network context and identification between the first routing infrastructure and the second routing infrastructure, wherein the first routing infrastructure operates under a first virtual networking technology and the second routing infrastructure operates under a second virtual networking technology.

2. The method according to claim 1, wherein the virtual network identifier is contained in a frame of the data packet, said method further comprising:
searching the frame of the data packet for the virtual network identifier.

3. The method according to claim 1, wherein the first virtual networking technology comprises Ethernet and the second virtual networking technology comprises Internet Protocol Generic Routing Encapsulation (IP-GRE) technologies.

4. The method according to claim 3, wherein the virtual network identifier comprises a Virtual Local Area Network (VLAN) identifier or a backbone service instance identifier (ISID) in Ethernet and wherein inserting the virtual network identifier further comprises inserting the virtual network identifier into at least a portion of an IP-GRE extension field.

5. The method according to claim 4, wherein the IP-GRE extension field comprises a KEY field and a SEQUENCE field.

6. The method according to claim 2, wherein the first routing infrastructure is to implement a plurality of different Ethernet technologies, said method further comprising:
maintaining a common virtual network identifier for the data packet in each of the plurality of different Ethernet technologies.

7. The method according to claim 1, wherein the virtual network identifier indicates a tenant network of a virtualized data center having multiple locations, wherein a first one of the locations comprises the first routing infrastructure, a second one of the locations comprises the third routing infrastructure, and wherein the first one and the second one of the locations are interconnected through the second routing infrastructure.

8. The method according to claim 1, further comprising encoding a quality of service indicator along with the virtual network identifier.

9. An apparatus comprising:
a module to access a data packet having a virtual network identifier in a first routing infrastructure, wherein the virtual network identifier indicates a tenant network, to encapsulate the data packet for transport through a second routing infrastructure, and to insert the virtual network identifier into the encapsulation of the data packet for routing of the data packet through the second routing infrastructure while maintaining virtual network context and identification between the first routing infrastructure and the second routing infrastructure, wherein the first routing infrastructure operates under a first virtual networking technology and the second routing infrastructure operates under a second virtual networking technology; and
a processor to implement the module.

10. The apparatus according to claim 9, wherein the virtual network identifier is contained in a frame of the data packet, and wherein the module is further to search the frame of the data packet for the virtual network identifier.

11. The apparatus according to claim 9, wherein the first virtual networking technology comprises Ethernet and the second virtual networking technology comprises Internet Protocol Generic Routing Encapsulation (IP-GRE) technologies, and wherein the module is further to insert the virtual network identifier into at least a portion of an IP-GRE extension field.

12. The apparatus according to claim 11, wherein the IP-GRE extension field comprises a KEY field and a SEQUENCE field.

13. A non-transitory computer readable storage medium on which is embedded a computer program, said computer program implementing a method, said computer program comprising computer readable code to:
accessing a data packet having a virtual network identifier in a first routing infrastructure, wherein the virtual network identifier indicates a tenant network;
encapsulating the data packet for transport of the data packet through a second routing infrastructure; and
inserting the virtual network identifier into the encapsulation of the data packet for routing of the data packet through the second routing infrastructure while maintaining virtual network context and identification between the first routing infrastructure and the second routing infrastructure, wherein the first routing infrastructure operates under Ethernet technology and the second routing infrastructure operates under an Internet Protocol Generic Routing Encapsulation (IP-GRE) technology.

14. The non-transitory computer readable storage medium of claim 13, wherein said computer program further comprises computer readable code to:
insert the virtual network identifier from an Ethernet frame into at least a portion of a KEY field and a SEQUENCE field in an IP-GRE extension field.

15. The non-transitory computer readable storage medium of claim 13, wherein said computer program further comprises computer readable code to:
encode a quality of service indicator along with the virtual network identifier.
